(19) United States
(12) Patent Application Publication
(10) Pub. No.: US 2016/0108154 A1
(43) Pub. Date: Apr. 21, 2016

(54) ACCELERATOR SYSTEM, A COMPOSITION COMPRISING A SYNTHETIC ISOPRENE POLYMER AND THE ACCELERATOR SYSTEM, AND DIPPED GOODS MADE FROM THE COMPOSITION

(71) Applicant: KRATON POLYMERS U.S. LLC, Houston, TX (US)

(72) Inventor: Lambertus Leonardus Marie KRUTZER, Duiven (NL)

(73) Assignee: KRATON POLYMERS U.S. LLC, HOUSTON, TX (US)

(21) Appl. No.: 14/881,459

(22) Filed: Oct. 13, 2015

(30) Foreign Application Priority Data
Oct. 15, 2014 (NL) 2013636

(51) Int. Cl. C08F 136/08

(52) U.S. Cl. CPC C08F 136/08

(57) ABSTRACT

This invention relates to an accelerator system comprising a sulphur donor, a carbamate or combination of carbamates as the only accelerator and optionally sulphur and optionally an activator, characterized in that the carbamate is a zinc dihydrocarbyldithiocarbamate, or a combination of zinc dihydrocarbyldithiocarbamates; a composition comprising a synthetic isoprene polymer latex and the accelerator system, and dipped goods made therefrom.

### FIELD OF THE INVENTION

This invention relates to an accelerator system for a synthetic isoprene polymer latex, a composition comprising the synthetic isoprene polymer latex and the accelerator system, and dipped goods made therefrom.

### BACKGROUND OF THE INVENTION

Accelerator systems have been developed, for instance by Charles Goodyear in 1839, for Natural Rubber. Accelerator systems are rather specific to the polymers they are intended to vulcanize. It is well-known that systems developed for NR not necessarily work for latexes based on synthetic isoprene polymers. Synthetic latexes based on isoprene polymers (homopolymers and (block) copolymers) are used as replacement for natural rubber in the synthesis of dipped goods. Dipped goods include surgical gloves and condoms. These goods are made for instance by dipping a mould into an aqueous dispersion of polyisoprene and curing the same. The curing is done with the use of an accelerator system. Complex accelerator systems are known, but these are not desired for logistic reasons and for reasons of regulatory nature.

The accelerator systems often comprise sulphur and/or a sulphur donor. For the purpose of this invention, as is common in the art, the definition of a sulphur donor excludes elementary forms of sulphur.

From U.S. Pat. No. 8,633,268 an accelerator system is known and claimed comprising a carbamate as the only accelerator. The example (example 3) is conducted with sodium dibutyldithiocarbamate. This is a water soluble dithiocarbamate. For the purpose of this invention, a water soluble dithiocarbamate has a solubility of more than 45 weight % in water at 25° C. The system in addition comprises a relatively high amount of sulphur or sulphur/sulphur donor combination. Also included is zinc oxide. Although an article is disclosed with a tensile strength greater than 3000 psi, it remains desirable to find a system with an improved tensile strength.

From U.S. Pat. No. 6,527,990 various systems are known that are used with various rubbers. Examples are provided with Sulphur. This may work for natural rubber. It should be noted however that synthetic isoprene polymer does not behave identical to natural rubber. The system disclosed in Table 4 of this reference was found to be not suitable for synthetic isoprene polymer.

From U.S. Pat. No. 6,828,387 an accelerator system is known comprising several accelerators. Complex systems are, however, undesirable for logistic reasons and for regulatory reasons.

Moreover, the system has a short pot life. It is desirable to have a system with an improved pot life. An improvement of pot life is important, as this allows extended use of the formulated system. This has now been found. This reference also includes an example wherein a single accelerator is used in combination with sulphur and zinc oxide. No sulphur donor is present. This example, sample 7, has insufficient tensile strength. This therefore strongly suggest that a single accelerator is ineffective.

In GB2436566 an accelerator system based on a dithiocarbamate is disclosed, which is used at low temperatures so as to minimize prevulcanization. In the examples a very low amount of zinc dibutyldithiocarbamate is used, in combination with sulphur and zinc oxide. No sulphur donor is present. No data on the tensile strength is provided. One would expect, based on U.S. Pat. No. 6,828,387 the tensile strength to be low.

From U.S. Pat. No. 3,678,135 an accelerator system is known for sulphur cure of blends of rubber of low unsaturation, particularly EPDM, with highly unsaturated rubbers such as SBR, NBR, etc. The system is not developed for a latex based on synthetic isoprene polymers. Similar systems for producing vulcanizates of EPDM and Diene rubber blends are known from U.S. Pat. No. 3,830,881. The systems contain substantial amounts of zinc oxide.

It is therefore desirable to have an accelerator system for a synthetic polymer latex with a relative simple composition that nonetheless achieves excellent cure.

### SUMMARY OF THE INVENTION

Accordingly, the invention provides an accelerator system for a synthetic isoprene polymer latex comprising with respect to 100 parts by weight of the synthetic isoprene polymer:
0.5 to 10 phr of a thiuram as sulphur donor;
0.05 to 2.0 phr of a carbamate or combination of carbamates as the only accelerator; and optionally at most 5.0 phr sulphur, and
optionally at most 2.5 phr of an activator, characterized in that the carbamate is a zinc dihydrocarbyldithiocarbamate, or a combination of zinc dihydrocarbyldithiocarbamates.

Moreover, the invention provides a composition comprising the synthetic isoprene polymer latex and the accelerator system, comprising a sulphur donor, a carbamate as the only accelerator and optionally sulphur and optionally an activator, characterized in that the carbamate is a zinc dihydrocarbyldithiocarbamate, or a combination of zinc dihydrocarbyldithiocarbamates.

Furthermore, the invention provides dipped goods comprising a synthetic isoprene polymer, obtainable by dipping a mould into a composition as claimed in any one of claims 4 to 6, comprising a synthetic isoprene polymer latex and an accelerator system as claimed in any one of claims 1 to 3, comprising a sulphur donor, a carbamate or combination of carbamates as the only accelerator and optionally sulphur and optionally an activator, characterized in that the carbamate is a zinc dihydrocarbyldithiocarbamate, or combination of zinc dihydrocarbyldithiocarbamates.

### DETAILED DESCRIPTION OF THE INVENTION

Synthetic isoprene polymers are known. They include polyisoprene (also known as isoprene rubber), copolymers or terpolymers of isoprene, and block copolymers of isoprene and styrene. Said polymers may be made by anionic polymerization, with Ziegler Natta catalysts or with Neodymium catalysts. Suitable latexes thereof include poly(isoprene) latex, poly(styrene/isoprene) latex, poly(styrene-b-isoprene-b-styrene) latex. They are readily available and can be obtained from KRATON Polymers Inc., USA and KRATON Polymers B.V., the Netherlands.

Blends of isoprene polymers can be used as well. Suitable poly(isoprene) blends can include e.g. poly(conjugated diene) and copolymers comprising styrene and thermoplastic material such as polyurethane and the like. A preferred isoprene polymer latex is KRATON IR-401 latex.

The salts of dithiocarbamates are well-known for their accelerating activity in sulphur vulcanization. An accelerator system preferably comprises a dihydrocarbyldithiocarbamate, wherein the hydrocarbyl groups independently may be alkyl or (substituted) aryl groups. The aryl group(s) preferably (independently) have 6 to 12 carbon atoms. The alkyl group(s) preferably independently have 1 to 6 carbon atoms. Also dithiocarbamates having two different groups, e.g. an aryl group and an alkyl group, may be used. Moreover, the expression hydrocarbyl includes groups further comprising one or more heteroatoms. An example thereof would be a piperidine group. The common dithiocarbamates are dimethyldithiocarbamate, diethyldithiocarbamate, dibutyldithiocarbamate, dibenzyldithiocarbamate, piperidine pentamethylenedithiocarbamate and ethylphenyldithiocarbamate. Preferred dithiocarbamates are diethyldithiocarbamate and dibutyldithiocarbamate. In case of ammonia or alkali metal as the cation the dithiocarbamate salt is soluble in water. If a multivalent metal ion (e.g. Zn²⁺) is the cation, the salt is almost insoluble in water. Often sodium dithiocarbamates are used as accelerator. The present inventor determined that if a carbamate or combination of carbamates is the only accelerator in the system, the tensile strength may be further improved, using a dithiocarbamate or combination of dithiocarbamates having Zn²⁺ as the cation. Zinc dithiocarbamates are almost insoluble in water at 25° C. Other insoluble dithiocarbamates may also be used advantageously. Zinc dihydrocarbyldithiocarbamates (single or combination) are preferred because of their commercial availability. The use of only zinc dithiocarbamates in combination with a sulphur donor is not yet known. Preferably zinc dibutyldithiocarbamate (ZDBC) or zinc diethyldithiocarbamate (ZDEC) or a combination of ZDBC and ZDEC are used.

The invention therefore also relates to a composition comprising synthetic isoprene polymer latex and an accelerator system comprising a sulphur donor, a dithiocarbamate (or combination) as the only accelerator and optionally sulphur and optionally an activator, characterized in that the dithiocarbamate is a zinc dihydrocarbyldithiocarbamate (single or combination). As indicated, other insoluble dithiocarbamates may also be used. For the purpose of this invention, a water insoluble dithiocarbamate has a solubility of (significantly) less than 45 weight % in water at 25° C. The accelerator is preferably in the range of 0.05 to 2.0 phr (parts per hundred parts of rubber). Preferably, the composition comprises a polyisoprene latex as rubber.

Very often zinc oxide is used as a vulcanization activator. In U.S. Pat. No. 3,830,881, for instance, 5 phr of zinc oxide is used. Interestingly, it was found that the present composition needs no zinc oxide. Minute amounts may be used, but this is not a requirement. This means that dipped goods with improved transparency may be made. The composition according to the present invention preferably contains no or less than 1.5 more preferably no or less than 0.5 phr zinc oxide.

The sulphur donor is a thiuram. Examples include monosulphides such as tetramethylthiuram monosulphide, disulphudes, such as tetramethylthiuram disulphide, tetraethylthiuram disulphide, dipentamethylenethiuram disulphide, and polysulphides, like dipentamethylene hexasulphide or dipentamethylene tetrasulphide. Also combinations may be used. More preferably the sulphur donor is dipentamethylene hexasulphide in combination with dipentamethylene tetrasulphide.

The amount of thiuram as sulphur donor is in the range of from 0.5 to 10 phr, more preferably in the range from 1 to 5 phr.

It is emphasized that the sulphur donor is a sulphur containing compound, which definition therefore excludes elemental sulphur. Elemental sulphur may be present, but is considered an optional component. Preferably at most 2.5 phr of elemental sulphur, if any at all, is employed, more preferably at most 2.0 phr of elemental sulphur, if any at all.

The invention is useful in manufacturing processes for elastomeric articles composed of a synthetic isoprene polymer latex. The invention affords the ability to produce synthetic poly(isoprene) articles which closely mimic the physical properties of elastomeric articles made from natural rubber latex. The invention can be advantageously incorporated into the manufacturing of surgical gloves, condoms, probe covers, dental dams, finger cots, catheters, and the like.

### DESCRIPTION OF THE EMBODIMENTS

The invention has been described with reference to various specific and preferred embodiments and techniques. However, it should be understood that many variations and modifications can be made while remaining within the spirit or scope of the invention as defined by the claims set forth below.

The preferred poly(isoprene) latex composition in accordance with the present invention can be prepared by mixing the components at an appropriate temperature (about room temperature) and pH (generally between 10 and 11). The obtained latex composition may be stored at about ambient temperature. A poly(isoprene) latex composition so produced can be stored for periods lasting up to about 8 days prior to its use in the dipping and curing process.

As an example of dipped goods, the preparation of an isoprene rubber glove by coagulant dipping is described below. Thus, for the preparation of a glove, a glove former is pre-heated in an oven and then dipped in a pre-prepared coagulant composition for a period of time and then removed there from. Next, the coagulant-coated former is placed in a drying oven for a time sufficient to dry the coagulant. The coagulant-coated former is removed from the oven and dipped into the poly(isoprene) latex composition. The coated former is removed and placed in an oven. The glove and former are removed from the oven and placed into a water leaching tank. The glove and former are removed from the leaching tank and placed drying at an elevated temperature for a period sufficient to dry the glove. This is the end of the first curing stage. At the second curing stage, the glove and former are placed in an oven heated to an increased temperature. The glove and former are removed and cooled to ambient temperature. Finally, the glove is stripped from the former. The gloves can be further treated in accordance with the particular needs, such as using lubrication, coating, halogenation, and sterilization techniques, all of which are conventional. Other conventional steps can be incorporated into the general process as well.

When prepared in accordance with the invention, elastomeric articles such as gloves exhibit the following physical properties: tensile strength of greater than about 17 MPa, elongation of greater than about 750% at break, and a tensile modulus of less than about 7 MPa at 500% elongation, as measured in accordance with ASTM D-412.

Condoms are typically made similarly, by straight dipping; without the use of a coagulant. Other elastomeric poly(isoprene) articles can be prepared using processes similar to those described herein, in combination with conventional equipment and techniques readily available in the art. For example, an elastomeric article in the form of a condom, can be prepared using a condom former.

The following example further illustrates the advantages of the invention and should not be construed as limiting the invention to the embodiments depicted therein.

### Preparation of the Composition

The latex was stirred at ambient temperature. 0.75 phr of Manawet™ 172 was added (Manawet is a trademark of Manufacturers Chemicals). The latex was diluted using demineralized water to 30 wt %, while under continuous stirring, the various components were added (sulphur donor, dithiocarbamate, anti-oxidant). The pH was adjusted to a value between 11 and 11.5 by the addition of 0.1 M KOH. The compositions were maintained at a temperature of 25° C. for 24 hours. In table 1 the formulation ingredients and their respective amounts have been specified. All amounts are expressed in parts per hundred dry rubber unless noted otherwise.

### Example of A Dipping Protocol (Coagulant Dipping)

As an example of dipped goods, the preparation of an isoprene rubber glove by coagulant dipping is described.

A coagulant solution of 15 wt % calcium nitrate, 5 wt % calcium carbonate and 0.1 wt % Trition X100 in demineralized water was prepared and heated to 60° C.

A glove former is pre-heated in an oven to a temperature of about 100° C. and then dipped in the coagulant solution for about 15 seconds. Next, the coagulant-coated former is placed in a drying oven at 100° C. for a time sufficient to dry the coagulant, typically about 2 minutes.

The coagulant-coated former is removed from the oven and dipped into the poly(isoprene) latex composition at ambient temperature, e.g., at a temperature ranging from about 15° C. to about 30° C. Depending on the latex concentration and dwell time of the former in the latex, thickness of the glove can be varied. The coated former is removed and placed in an oven at a temperature of about 100° C. for about 1 minute. The glove and former are removed from the oven and placed into a water leaching tank having a temperature of about 50° C., for about 5. The glove and former are removed from the leaching tank and crosslinked in an oven at 130° C. for 20 minutes. Crosslinking may be done at lower temperature, but cure time then has to be adjusted. The glove and former are removed from the oven and cooled to ambient temperature. Finally, the glove is stripped from the former.

### Physical Properties

Tensile strength (TS), elongation at break (EB), and tensile moduli at 500% and 100% elongation (TM500, TM100) were measured in accordance with ASTM D-412. The properties were determined using an Instron 5565, equipped with grips 2713-001 and a Long Travel (XL) extensometer. Transparency of dipped films was measured using a Byk-Gardner HazeGard.

### EXAMPLES

The following products were used.

| | |
|---|---|
| IR | An aqueous latex of polyisoprene with a total solids content |
| 401 ™ | of about 65%, manufactured by Kraton Polymers |
| SIS | An aqueous latex of a branched poly(styrene-b-isoprene) block |
| | copolymer having a polystyrene content of 11%, polystyrene |
| | blocks of molecular weight 10700, and an apparent molecular |
| | weight of 438000. The latex had a total solids content of |
| | about 65%, manufactured by Kraton Polymers |
| NaDBC | Solution of Sodium dbutyldithiocarbamate in water, solids |
| | content 45 wt. % |
| ZDBC | Dispersion of Zinc dibutyldithiocarbamate in water, solids |
| | content of 50 wt. % |
| ZDEC | Dispersion of Zinc diethyldithiocarbamate in water, solids |
| | content 50 wt. % |
| ZnO | Dispersion of Zinc oxide in water, solids content 50 wt. % |
| AO | Dispersion of Antioxidant in water, solids content 50 wt. % |
| DPTH | Dispersion of Dipentamethylenethiuram hexasulphide, (sulphur |
| | donor) in water, solids content 50 wt. % |
| S | Dispersion of sulphur in water, solids content 60 wt. % |

TABLE 1
Composition (in parts per hundred parts of rubber)

| | Comp. 1 | 2 | 3 | 4 | 5 | 6 | 7 | 8 |
|---|---|---|---|---|---|---|---|---|
| IR 401 | 100 | 100 | 100 | 100 | 100 | | — | — |
| ZN IR | — | — | — | | | 100 | — | — |
| SIS | — | — | — | | — | | 100 | 100 |
| Manawet172 | 0.75 | 0.75 | 0.75 | 0.75 | 0.75 | 0.75 | 0.75 | 0.75 |
| Sulphur | 2.0 | 2.0 | 2.0 | 2.0 | | 2.0 | | |
| DPTH | 1.0 | 1.0 | 1.0 | 1.0 | 1.5 | 1.0 | 1.0 | 0.5 |
| NaDBC | 0.1 | — | — | | — | | — | — |
| ZDBC | — | 0.1 | 1.0 | 1.0 | | 1.0 | | — |
| ZDEC | — | | | | 1.0 | | 1.0 | 0.5 |
| ZnO | 1.5 | 1.5 | 1.5 | | — | | — | — |
| AO | 1.0 | 1.0 | 1.0 | 1.0 | 1.0 | 1.0 | 1.0 | 1.0 |

TABLE 2
Physical Properties After One Day of Maturation

| | Comp. 1 | 2 | 3 | 4 | 5 | 6 | 7 | 8 |
|---|---|---|---|---|---|---|---|---|
| TS (MPa) | 0.62 | 20.22 | 23.71 | 27.95 | 24.37 | 17.57 | 28.8 | 23.3 |
| EB (%) | 1540 | 1083 | 964 | 959 | 1058 | 831 | 886 | 1055 |
| TM100 (MPa) | 0.32 | 0.42 | 0.54 | 0.62 | 0.52 | 0.53 | 0.70 | 0.57 |
| TM500 (MPa) | 0.26 | 1.27 | 1.91 | 2.03 | 1.45 | 1.60 | 3.70 | 1.60 |

TABLE 3
Physical Properties of Sample 5, for Different Maturation Times

| | Day 0 | Day 1 | Day 2 | Day 7 | Day 14 | Day 21 | Day 28 |
|---|---|---|---|---|---|---|---|
| TM100 (MPa) | 0.52 | 0.52 | 0.48 | 0.51 | 0.48 | 0.53 | 0.66 |
| TM500 (MPa) | 1.3 | 1.45 | 1.36 | 1.5 | 1.35 | 1.52 | 2.11 |
| TS (MPa) | 18.74 | 24.37 | 22.96 | 23.35 | 22.2 | 23.11 | 23.29 |
| EB (%) | 1065 | 1058 | 1071 | 1017 | 1089 | 1007 | 923 |

### Comparative Experiment 1

An accelerator system identical to Example 3 of U.S. Pat. No. 8,633,268 was made. This was combined with a synthetic polyisoprene latex (IR401 by Kraton).

### Experiment 2

Similar to comparative Experiment 1 an experiment was carried out using ZDBC instead of NaDBC. The results are included in Table 2. Improvements are found with respect to tensile strength.

### Experiment 3

Similar to Experiment 2, but now with more ZDBC. Better mechanical properties were obtained.

### Experiment 4

Similar to Experiment 3, but now without ZnO. The mechanical properties of the dipped goods were similar to those obtained in experiment 3, showing that ZnO is not necessary.

### Experiment 5

Similar to Experiment 4, but now without sulphur, and with ZDEC instead of ZDBC. Physical properties obtained are similar to those of experiment 4, showing that sulphur is not necessary.

### Experiment 6

This experiment shows that with this formulation good mechanical properties can also be obtained using a Ziegler-Natta polyisoprene latex.

### Experiments 7 and 8

Similar to Experiment 2, using a block copolymer. In this case the amount of the accelerator system and the other components were adapted. This experiment illustrates the applicability of a sulphur donor and ZDEC with block copolymers.

In table 3 it is shown that the pot life of the formulation is at least 28 days.

To illustrate the transparency difference two latex samples were compounded by first diluting the latex to 60% using demineralized water. While under continuous stirring, 1 phr AO, 1.35 phr DPTH, and 1 phr ZDBC were added. To one of the two samples 1.5 phr ZnO was added.

Coagulant solution was prepared by dissolving 500 gram Ca(NO3)2.4H2O and 0.1 gram triton X100 in 500 gram water. Thick films were prepared as described before, but now the dwell time in the compounded latex was 10 minutes.

The film without ZnO having a thickness of 1.5 mm showed a transparency of 82%, the film containing ZnO had a thickness of 1.47 mm and had a transparency of 59%.

1. A composition comprising: (a) a synthetic isoprene polymer; and (b) an accelerator system with respect to 100 parts by weight of the synthetic isoprene polymer wherein the composition comprises:
0.5 to 10 phr of a thiuram as sulphur donor:
0.05 to 2.0 phr of a carbamate or combination of carbamates as the only accelerator and
optionally at most 5.0 phr sulphur and
optionally at most 2.5 phr of an activator, characterized in that the carbamate is a zinc dihydrocarbyldithiocarbamate, or a combination of zinc dihydrocarbyldithiocarbamates.

2. The composition according to claim 1, wherein the hydrocarbyl groups independently may be alkyl or (substituted) aryl groups, preferably wherein the aryl group(s) (independently) have 6 to 12 carbon atoms and/or preferably wherein the alkyl group(s) (independently) have 1 to 6 carbon atoms.

3. The composition according to claim 1, wherein the carbamate is a zinc dialkyldithiocarbamate, preferably zinc dibutyldithiocarbamate (ZDBC) or zinc diethyldithiocarbamate (ZDEC), or a combination of ZDBC and ZDEC.

4. A good comprising a composition a comprising synthetic isoprene polymer latex and an accelerator system, comprising 0.5 to 10 phr of a thiuram as sulphur donor, 0.05 to 2.0 phr of a carbamate as the only accelerator and optionally at most 5.0 phr sulphur and optionally at most 2.5 phr of an activator, wherein the carbamate is a zinc dihydrocarbyldithiocarbamate, or a combination of zinc dihydrocarbyldithiocarbamates.

5. The good according to claim 4, wherein the amount of carbamate is in the range of 0.05 to 2.0 phr.

6. The good according to claim 4, wherein the synthetic isoprene polymer latex is a polyisoprene latex.

7. The good according to any one of claim 4, containing no or less than 0.5 phr zinc oxide.

8. The good of claim 4, wherein the good is a dipped good obtainable by dipping a mould into the composition.
